(19) United States
(12) Patent Application Publication
(10) Pub. No.: US 2011/0057374 A1
(43) Pub. Date: Mar. 10, 2011

(54) Worktable and Its Mounting Structure

(76) Inventor: James Liu, Ta-Li (TW)

(21) Appl. No.: 12/688,970

(22) Filed: Jan. 18, 2010

(30) Foreign Application Priority Data
Sep. 10, 2009 (TW) 98130551
Dec. 2, 2009 (TW) 98222564

(51) Int. Cl. B23Q 1/25; B23Q 1/03; A47B 37/00; B23Q 3/18; B23Q 3/00

(52) U.S. Cl. 269/289 R; 108/59; 108/50.11

(57) ABSTRACT

A worktable includes a first platform made of metal, a mounting structure fixed to the first platform and being utilized to mount the first platform on a machine, and at least one second platform made of granite and detachably joined to a lateral peripheral edge of the first platform and connected to the mounting structure in order to prevent the at least one second platform from disengagement from the first platform. Additionally, the first platform includes a first top side and the at least one second platform includes a second top side cooperating with the fist top side to form a flat surface, and with the flat surface adapted to allow a workpiece that is moved thereon to be manufactured precisely.

### BACKGROUND OF THE INVENTION

1. Field of the Invention

The present invention relates to a worktable for a machine and, in particular, to a worktable including a first platform which can be mounted on a machine through a mounting structure and a second platform made of a material which is characterized by a superior ability to remain flat and to resist against any intrinsic and extrinsic deformation, and which cooperates with the first platform to from a surface such that a workpiece moved thereon can be manufactured precisely.

2. Description of the Related Art

Generally, machines and, particularly woodworking machines, have their worktables made of cast iron. Additionally, the woodworking machine would generally utilize a protractor to assist aligning workpieces precisely, and the worktable generally includes a slot in which the protractor is slidably installed. However, it is often encountered that the protractor is not working effectively, and the cause of the problem appears to be that the cast iron made worktable is liable to suffer thermal expansion and contraction.

The present invention is, therefore, intended to obviate or at least alleviate the problems encountered in the prior art.

### SUMMARY OF THE INVENTION

According to the present invention, a worktable includes a first platform including a plurality of channels and of that each is formed adjacent to a lateral peripheral edge thereof. The first platform includes a first top side from which each of the plurality of channels is recessed. In addition, each of the plurality of channels defines a base side and a lateral side extending from the first top side and base side. The worktable further includes at least one second platform including a lateral peripheral edge contacting with the lateral peripheral edge of the first platform. The lateral edge of the second platform, and the base side and lateral side of the associated channel cooperates to from a passage which has an opening being level and between the first and second top sides.

It is an object of the present invention that the first platform saves manufacturing connections on the at least one second platform which are used to connect the at least one second platform with the machine

It is another object of the present invention that the first top side and second top side cooperating together to form a flat and flush surface on which a workpiece is moved during its manufacture thereof.

Other objects, advantages, and new features of the present invention will become apparent from the following detailed description of the invention when considered in conjunction with the accompanied drawings

### BRIEF DESCRIPTION OF THE DRAWINGS

FIG. 1 is a perspective view of a worktable and its mounting structure in accordance with a first embodiment of the present invention, and with the worktable mounted on a machine.

FIG. 2 is an exploded perspective view of the worktable and its mounting structure embodying the present invention.

FIG. 3 is another exploded perspective view of the worktable and its mounting structure embodying the present invention taken from a different angle of view.

FIG. 4 is a cross-sectional view of the worktable and its mounting structure embodying the present invention taken along line 4-4 of FIG. 1.

FIG. 5 is a cross-sectional view of the worktable and its mounting structure embodying the present invention taken along line 5-5 of FIG. 1.

FIG. 6 is a partial, enlarged view of FIG. 4.

FIG. 7 is a partial, enlarged view of FIG. 3.

FIG. 8 is a partial, enlarged view of FIG. 5.

FIG. 9 is an exploded perspective view of a joining device used on the mounting structure embodying the present invention.

FIG. 10 is a schematic view illustrating assembly of the worktable embodying the present invention.

FIG. 11 is a cross-sectional view of the worktable and its mounting structure embodying the present invention taken along line 11-11 of FIG. 1.

FIG. 12 is a partial, enlarged view of FIG. 11.

FIG. 13 is an exploded perspective view of a worktable and its mounting structure in accordance with a second embodiment of the present invention.

FIG. 14 is another exploded perspective view of the worktable and its mounting structure embodying the second embodiment of the present invention taken from a different angle of view.

FIG. 15 is a partial, enlarge view of the worktable and its mounting structure embodying the second embodiment of the present invention.

### DETAILED DESCRIPTION OF THE PREFERRED EMBODIMENT

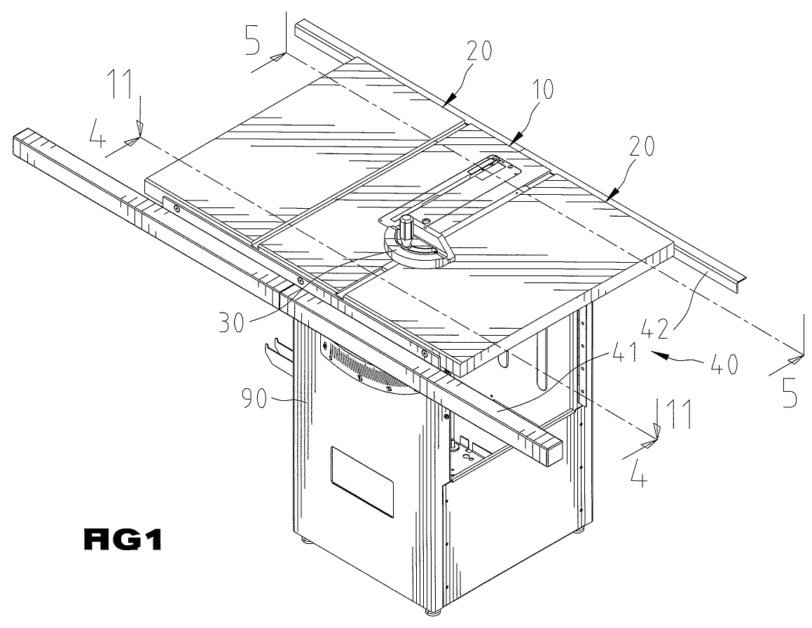

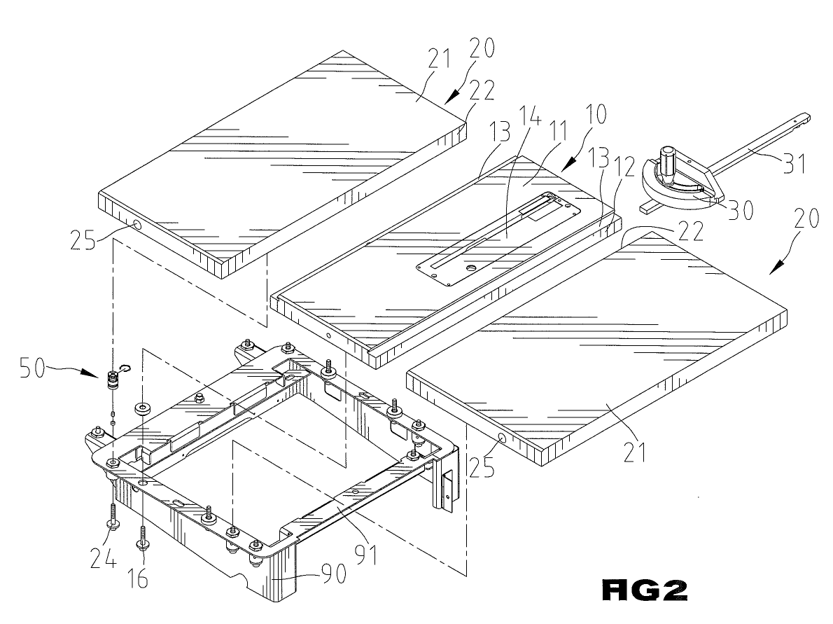

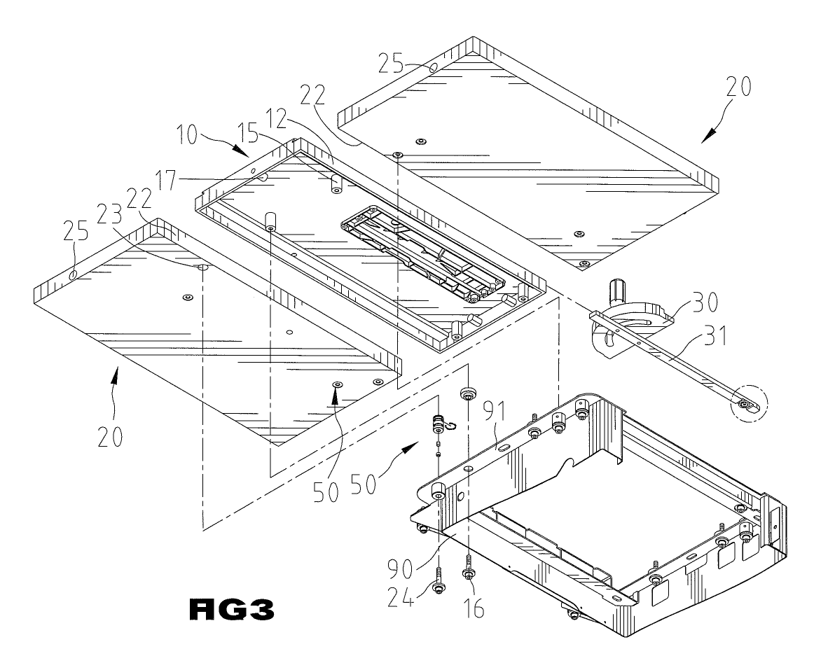

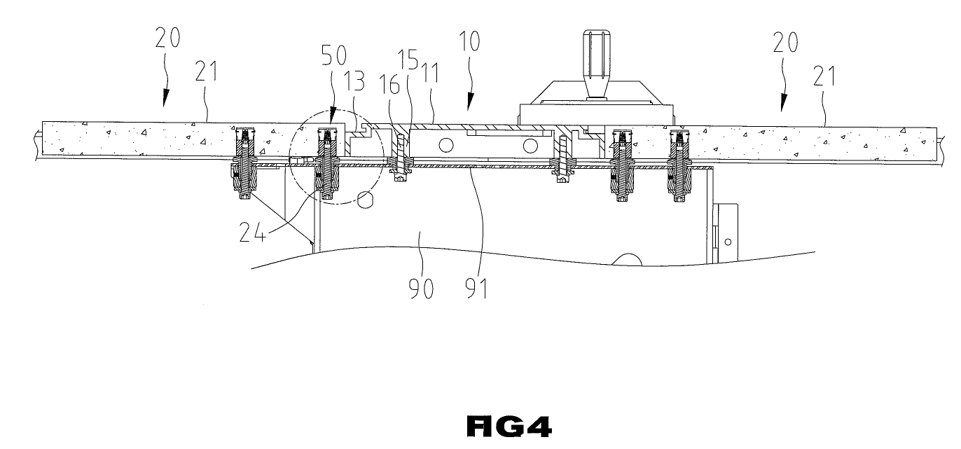

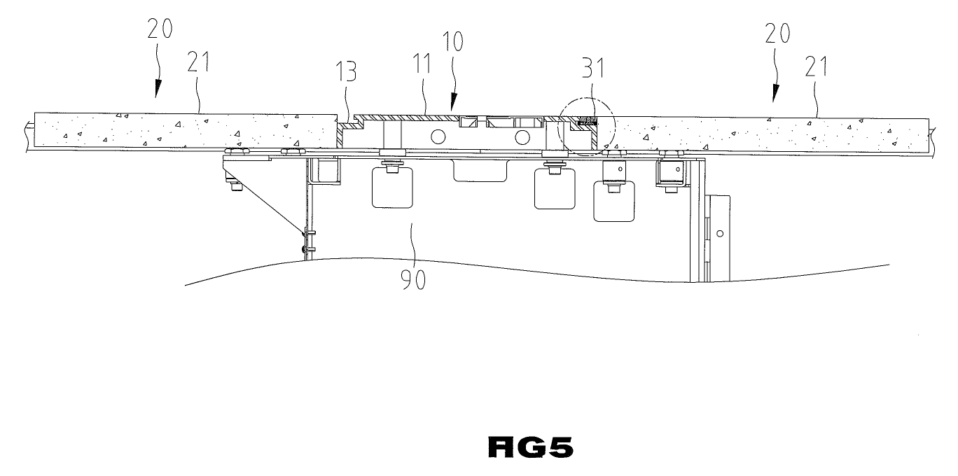

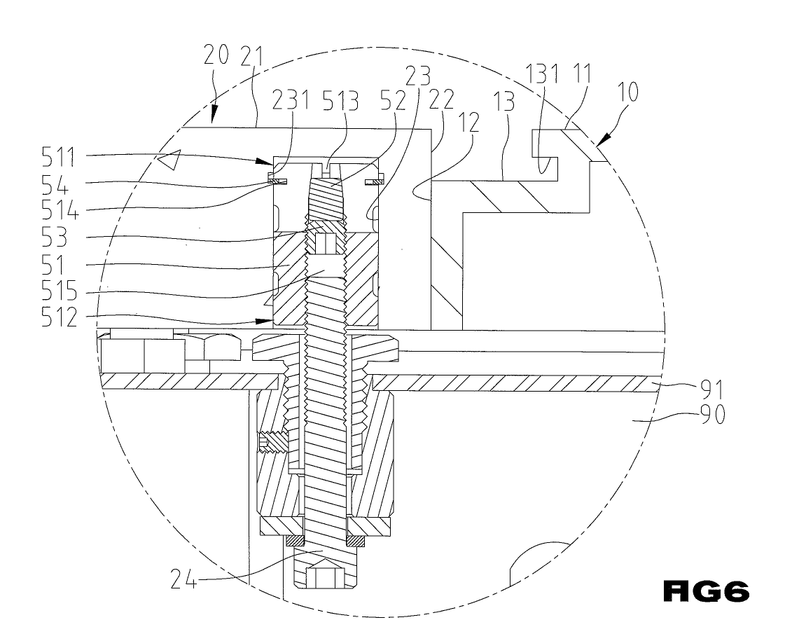

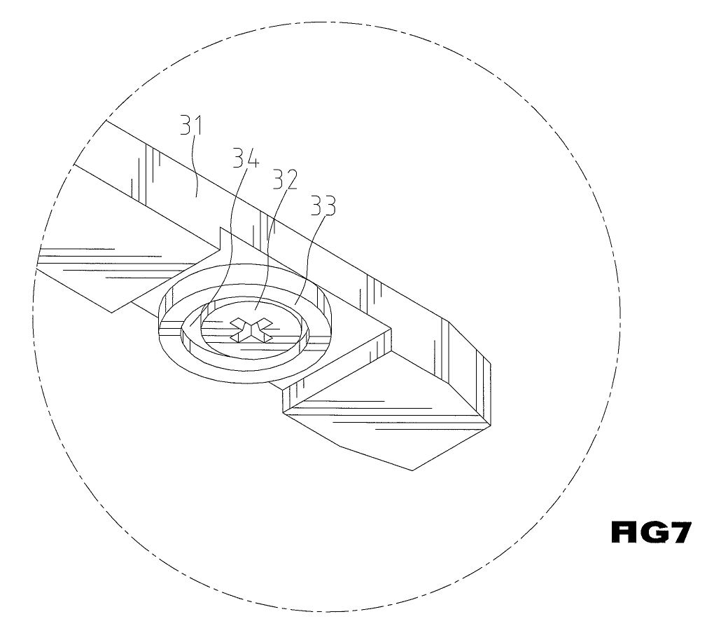

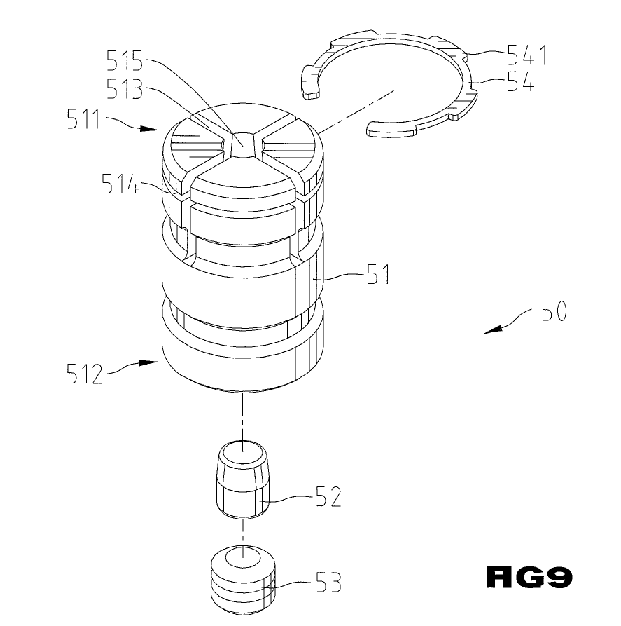

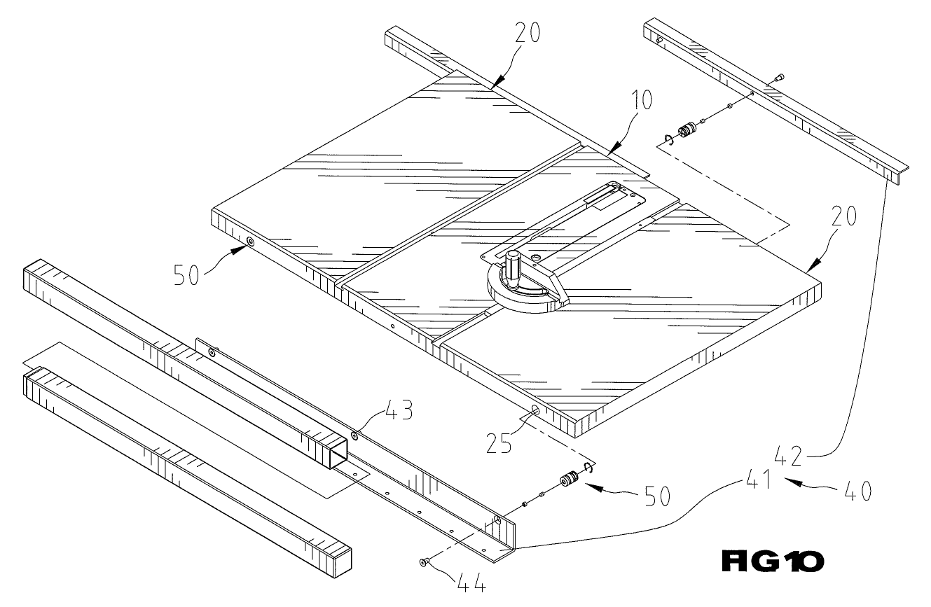

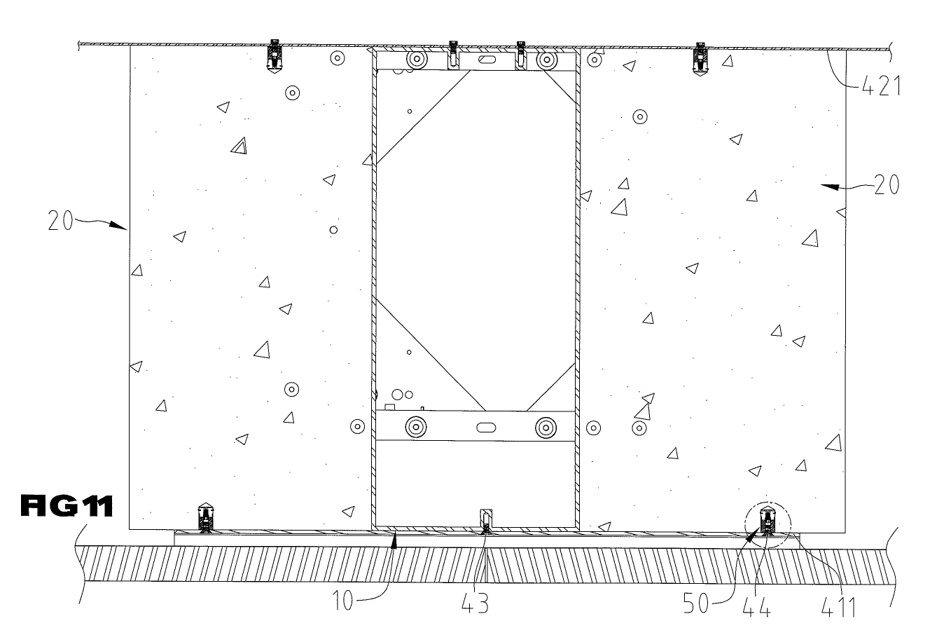

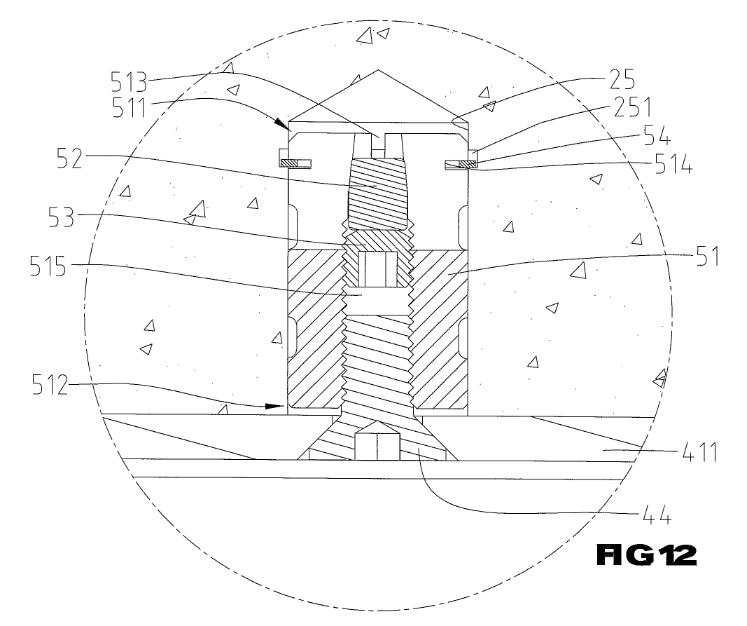

Referring to the FIGS. 1 through 12, a worktable in accordance with a first embodiment of the present invention includes a first platform 10, a mounting structure 91 fixed to the first platform 10 so as to mount the first platform 10 on a pedestal 90 for a machine securely. For easy connection with the mounting structure and manufacture, the first platform 10 is made of metal.

The worktable further includes two second platforms 20 detachably joined to a lateral peripheral edge 12 of the first platform 10 such that the first platform 10 is disposed between the two second platforms 20. Each second platform 20 includes a lateral peripheral edge 22 contacting with the lateral edge 12 of the first platform 10 after the first 10 and second 20 platforms are joined one another. Additionally, each second platform 20 is made of granite.

The first platform 10 includes a first top side 11 and each second platform 20 includes a second top side 21 cooperating with the fist top side 11 to form a flat and flush surface such that the flat surface on which a workpiece is moved during its manufacture thereof and the workpiece can be manufactured precisely.

Basically, each of the granite made second platforms 20 has a superior ability to remain flat and to resist against any intrinsic and extrinsic deformation because granite has hardness of 5-7 according to Moh's hardness, which is 8 times higher than steel, and 2.5 times higher than cast steel, and is not susceptible to erosion caused by acid, and can sustain at least the pressure of 2000 thousand gram per square millimeter. In addition, granite is insulated from magnetic forces, and is not sticky to foreign matters, as well as is resistant to intrinsic deformation caused by temperature and humidity changes, and is able to be maintained and cleaned easily. In this regard, since it is difficult and is costly to manufacture granite made second platforms 20, the applicant of the present invention has avoided manufacturing the second platforms 20 as much as possible, and components such as a plurality of channels 13, and a cavity for receiving a seat 14 for a cutting blade are manufactured on the first platform 10. Furthermore, the second top side 21 of each second platform 20 has a cross-sectional area being larger than a cross-sectional area of the first top side 11 of the first platform 10 so as to make full use of granite made second platforms 20.

The first platform 10 also includes a plurality of first joints 15 utilized for fixing it to the mounting structure 91. The mounting structure 91 includes two opposing sides including a first side and a second side and of that one of the first and second sides is utilized to connect to the pedestal 90, thereby fixing the mounting structure 91 on the pedestal 90. The mounting structure 91 further includes a plurality of first apertures extending through the first and second sides, and when it is fixed to the first platform 10, the plurality of joints 15 on the first platform 10 are disposed correspondingly to the plurality of first apertures, respectively. Further, a plurality of first fasteners 16 are utilized to connect the fist platform 10 to the mounting structure 90, and each first fastener 16 is partially disposed in one first aperture and is partially disposed in one first joint 15 thereafter. Preferably, each first fastener 16 is installed by inserting through the associated first aperture and is fixed in the associated first joint 15. Preferably, each first fastener 16 includes a threaded section and the associated first joint 15 includes a threaded section that the threaded section of the first fastener 16 can engage, thereby fixing the first fastener 16 in the first joint 15. Further, a plurality of spacers may be disposed between the first platform 10 and the mounting structure 91 to ensure secure engagement therebetween. Moreover, each spacer is inserted by one first fastener 16.

As to the plurality of channels 13, each channel 13 is formed adjacent to the lateral peripheral edge 12 of the first platform 10 and extends therealong. Each channel 13 is also recessed from the first top side 11 of the first platform 10 so it includes a base side spaced from a bottom side of the first platform 10 at a first distance, and the first distance is smaller than a second distance measured between the first top side 11 and the bottom side of the first platform 10. In this regard, each channel 13 includes a lateral side extending from the first top side 11 of the first platform 10 to the base side. Furthermore, each channel 13 includes a ridge 131 extending from the lateral side thereof. However, it is understood the ridge 131 of each channel 13 can extend from one of the lateral side of each of the plurality of channels 13 and the lateral edge of the associated second platform 20. In addition, the ridge 131 is spaced from the base side and doesn't protrude over the first top side 11. Preferably, each ridge 131 has its most upper side being flush with the first top side 11 and second top side 21.

Further, since the second platform 20 that is joined to the first platform 10 has its lateral peripheral edge 22 contacting with the lateral peripheral edges 12 of the first platform 10, so the lateral edge 22 of the second platform 20, and the base side and lateral side of the associated channel 13 would cooperate to from a passage with an opening which is level and between the first 11 and second 21 top sides, and the opening has a width delimited by a distance between the ridge 131 formed on the first platform 10 and the second top side 21 of the second platform 20.

Furthermore, a protractor 30 is adapted to be disposed in one of the plurality of channels 13. The protractor 30 includes a mounting member 31 engaged in the channel 13. The mounting member 31 also includes two opposing sides including an upper side and a lower side and a roller 33 fixed on the lower side thereof by an axle 32. Additionally, the roller 33 has a diametrical size larger than the width of the opening of the associated channel 13.

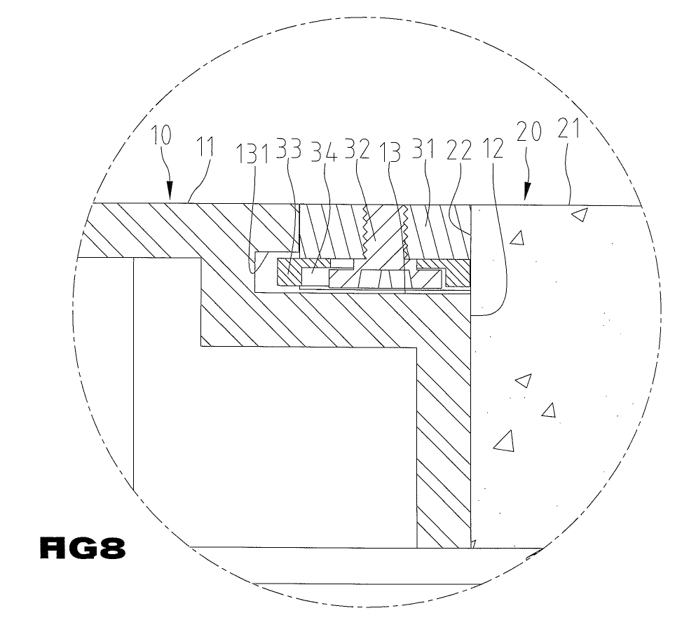

As to the axle 32, the axle 32 includes a body inserting through an orifice formed in the roller 33 and engaging in the mounting member 31 such that the roller 33 is pivotal with respect to the body. The axle 32 further includes a head formed on the body, and which includes a diametrical size larger than a diametrical size of the orifice of the roller 33, thereby retaining the roller 33 between the head of the axle 32 and the lower side of the mounting member 31. Furthermore, the roller 33 includes an inner peripheral edge spacing from the axle 32 by a gap 34 so as to allow it to move and be limited by the head of the axle 32. Specifically, the roller 33 has an outer peripheral edge urged by the lateral peripheral edge 22 of the second platform 20 associated with the channel 13 in which the mounting member 31 of the protractor 30 is disposed, and the roller 33 has a portion of its outer peripheral edge disposed between the ridge 131 and base side of the channel 13 so as to prevent the protractor 30 from unintended disengagement from the channel 13, as shown in FIG. 8. FIG. 8 also shows that roller 33 includes its outer peripheral edge urged by the lateral edge 22 of the second platform 20 on the right, and the second platform 20 is disposed on the right of the first platform 10. Likewise, if the protractor 30 is disposed in the channel 13 that cooperates with the platform 20 disposed on the left of the first platform 10, the roller 33 would have its outer peripheral edge urged by the lateral edge 22 of the second platform 20 on the left.

In addition, in order to prevent the second platforms 20 from disengagement from the first platform 10 each second platform 20 includes a bottom side fixed to the mounting structure 91. Further, a plurality of orifices 23 are recessed from the bottom side of each second platform 20. Preferably, the plurality of orifices 23 in each second platform 20 are disposed adjacent to its lateral peripheral edge 22 with which the lateral peripheral edge 12 of the first platform 10 contacts upon engagement of the first platform 10 and this second platform 20. The mounting structure 91 also includes a plurality of second apertures extending through the first and second sides, and when the second platforms 20 are fixed to the mounting structure 91, the plurality of orifices 23 in the second platforms 20 are disposed correspondingly to the plurality of second apertures, respectively. Additionally, a plurality of engaging device 50 and second fasteners 24 cooperated therewith are utilized to connect the second platforms 20 to the mounting structure 90, and each engaging device 50 is disposed in one orifice 23 and is prevented from disengagement therefrom while the associated second fastener 24 is partially disposed in the engaging device 50 and is partially disposed in one second aperture thereafter.

Each engaging device 50 includes a body 51 including a proximal end 511 and a distal end 512, a hole 515 extending from the proximal end 511 to distal end 512, and a plurality of slots 513 each extending along the body 51 and formed on the proximal end 511 thereof. In addition, each slot 513 extends diametrically from one point on its outer periphery to another point and across the hole 512 such that the hole 512 is connected with and is in communication with each slot 513. Each engaging device 50 further includes a pressing member 52 disposed in the hole 515 to expand the proximal end 511 of the body 51 such that the body 51 has its outer periphery abutting against a circumferential wall of the associated orifice 23, thereby tight-engaging and retaining the body 51 in the orifice 23. Each engaging device 50 also includes a pushing member 53 disposed in the hole 515 to urge the pressing member 52 towards the proximal end 511 of the body 51 until the body 51 is tight-engaged in the orifice 23.

Preferably, the hole 515 in the body 51 has a threaded section formed thereon and the pushing member 53 has a threaded section that the threaded section of the body 51 can engage, thereby retaining the pushing member 53 in the hole 515.

Preferably, the second fastener 24 that cooperates with the engaging device 50 includes a shank with a threaded section. Additionally, the shank is inserted through the mounting structure 91. Moreover, the threaded section on the shank of the second fastener 24 can be engaged with the threaded section of the body 51, thereby fixing the associated second platform 20 on the mounting structure 91.

Preferably, the mounting structure 91 includes a plurality of couplers and adjusters cooperated therewith mounted thereon and inserted by the plurality of second fasteners 24, respectively. Further, each adjuster is moveable relative to the associated coupler so as to make the associated second platform 20 including its second top side 22 being level with the first top side 11 of the first platform 10.

In addition, the body 51 of each engaging device 50 may include a groove 514 recessed from its outer periphery edge and extending annularly therealong, and a clip 54 is engaged in the groove 514. Furthermore, each orifice 23 may include a recess 231 extending annularly from its circumferential wall. In this regard, when each engaging device 50 is disposed in one orifice 23, the clip 54 on the associated body 51 is partially engaged in the groove 514 and is partially engaged in the recess 231 of the associated orifice 23, thereby preventing the engaging device 50 disengaging from the orifice 23. Preferably, the clip 54 includes a plurality of locking sections 541 extending radially outwardly from its outer circumferential wall so as to increase its structural area engaged in the associated recess 231, thereby preventing the clip 54 from disengaging from the recess 231 accidentally.

Further, a track mechanism 40 for a fence which is a common component on a machine as guiding apparatuses is adapted to be mounted on the worktable of the present invention. The fencing device 40 includes a plurality of tracks including a first track 41 and a second track 42. Furthermore, the first platform 10 includes a portion of its lateral peripheral edge 12 cooperating with a portion of the lateral peripheral edge 22 of one second platform 20 and a portion of the lateral peripheral edge 22 of the other second platform 20 to form a first side on which the first track 41 is mounted. Preferably, the first side is straight and flat. Likewise, the first platform 10 includes another portion of its lateral peripheral edge 12 cooperating with another portion of the lateral peripheral edge 22 of one second platform 20 and another portion of the lateral peripheral edge 22 of the other second platform 20 to form a second side on which the second track 42 is mounted. Preferably, the second side is straight and flat. Additionally, the first platform 10 includes a plurality of second joints 17 utilized for fixing it to the first 41 and second 42 tracks. Both the first and second sides have second joints 17 extending therefrom. Further, a plurality of third fasteners 43 are utilized connect the first 41 and second 42 tracks to the first platform 10, and each third fastener 43 is partially disposed in one second joint 17 and is partially disposed in the associated one of the first 41 and second 42 tracks thereafter.

Preferably, each third fastener 43 is installed by inserting through the selected one of the first 41 and second 42 tracks and is fixed in the associated second joint 17. Preferably, each third fastener 43 includes a threaded section and the associated second joint 17 includes a threaded section that the threaded section of the second fastener 17 can engage, thereby fixing the third fastener 43 in the first joint 17.

In addition, in order to fix the track mechanism 40 to the second platforms 20 both the first and second sides include a plurality of orifices 25 recessed therefrom and each orifice 25 includes one engaging device 50 disposed therein, and a fourth fasteners 44 is cooperated with one engaging device 50 to connect the track mechanism 40 to the second platforms 20. Likewise, the engaging devices 50 that are disposed in the respective orifices 25 are prevented from disengagement therefrom. Furthermore, each fourth fastener 44 is partially disposed in the engaging device 50 and is partially disposed in the associated one of the first 41 and second 42 tracks thereafter.

Preferably, the fourth fastener 44 that cooperates with the engaging device 50 includes a shank with a threaded section. Additionally, the shank is inserted through associated one of the first 41 and second 42 tracks. Moreover, the threaded section on the shank of the fourth fastener 44 can be engaged with the threaded section of the body 51, thereby fixing the track mechanism 40 to the second platforms 20.

Likewise, each orifice 25 may include a recess 251 extending annularly from its circumferential wall. In this regard, when each engaging device 50 is disposed in one orifice 25, the clip 54 on the associated body 51 is partially engaged in the groove 514 and is partially engaged in the recess 251 of the associated orifice 25, thereby preventing the engaging device 50 disengaging from the orifice 25.

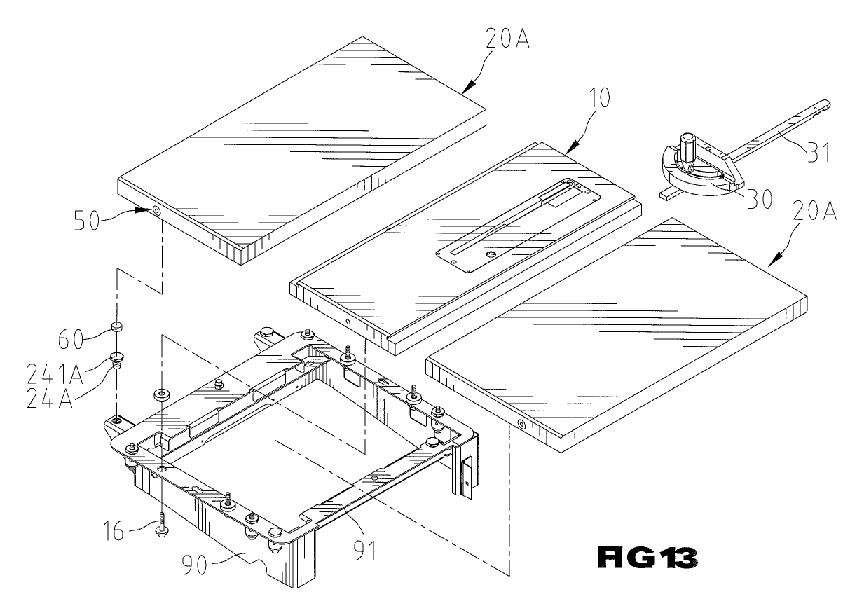

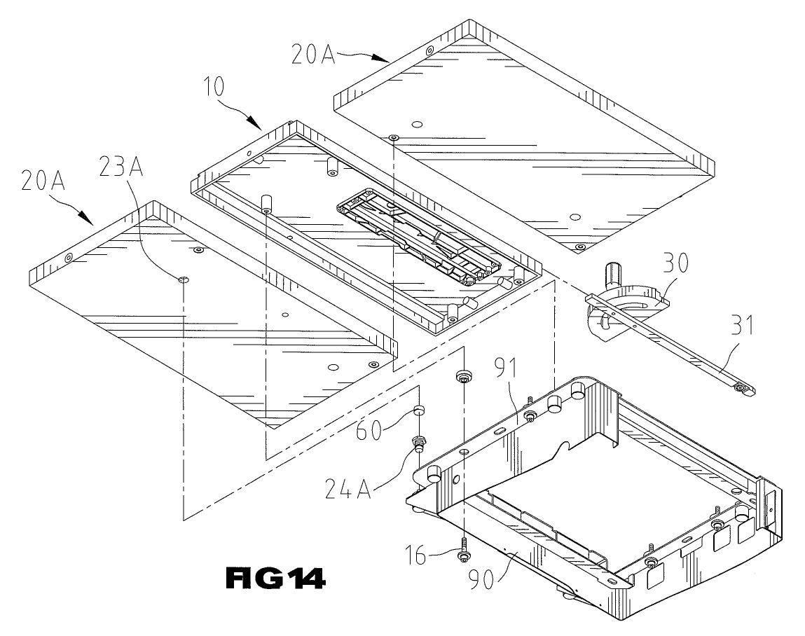

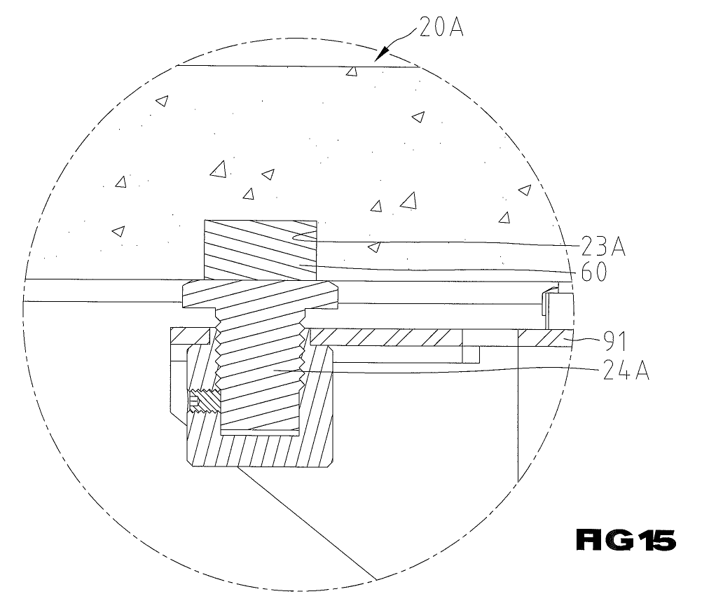

Referring to the FIGS. 13 through 15, a worktable in accordance with a second embodiment of the present invention differentiates from the first embodiment in that it utilize a different way to fix second platforms 20A to the mounting structure 91. In this embodiment, each second platform 20A includes a plurality of orifices 23A recessed from its bottom side. Instead of engaging devices 50, each orifice 23A includes a magnetic member 60 disposed therein. Additionally, each second fastener 24 is substituted by a second fastener 24A to cooperate with one magnetic member 60. In this regard, each second platform 20A is mounted to the mounting structure 91 by magnetic attraction between the associated magnetic members 60 and second fasteners 24A.

While the specific embodiments have been illustrated and described, numerous modifications come to mind without significantly departing from the spirit of invention, and the scope of invention is only limited by the scope of the accompanying claims.

What is claimed is:

1. A worktable for a machine comprising:
a first platform including a plurality of channels and of that each is formed adjacent to a lateral peripheral edge thereof, and a first top side from which each of the plurality of channels is recessed, and with each of the plurality of channels defining a base side and a lateral side extending from the first top side and base side; and
at least one second platform including a lateral peripheral edge contacting with the lateral peripheral edge of the first platform, with the lateral edge of the second platform, and the base side and lateral side of the associated channel cooperating to from a passage which has an opening being level and between the first and second top sides.

2. The worktable as claimed in claim 1 wherein the first platform is made of metal, and wherein the at least one second platform is made of granite, and wherein the first platform saves manufacturing connections on the at least one second platform which are used to connect the at least one second platform with the machine, and wherein the first platform includes a first top side and the at least one second platform includes a second top side cooperating with the fist top side to form a flat and flush surface on which a workpiece is moved during its manufacture thereof.

3. The worktable as claimed in claim 1 wherein one of the lateral side of each of the plurality of channels and at least one second platform includes a ridge extending from the lateral edge thereof.

4. The worktable as claimed in claim 1 wherein the first top side of the first platform defines a first cross-sectional area, and wherein the second top side of the at least one second platform defines a second cross-sectional area being greater than the first cross-sectional area.

5. The worktable as claimed in claim 1 wherein the mounting structure includes two opposing sides including a first side and a second side, and wherein the first platform includes a plurality of first joints cooperating with a plurality of fasteners upon fixing the first platform to the mounting structure, and with each of the plurality of fasteners extending through the first and second sides of the mounting structure.

6. The worktable as claimed in claim 3 wherein the ridge is spaced from the base side and doesn't protrude over the first top side of the associated channel.

7. The worktable as claimed in claim 1 further comprising a protractor selectively disposed in one of the plurality of channels.

8. The worktable as claimed in claim 7 wherein the protractor includes a mounting member, an axle, and a roller fixed on a lower side of the mounting member by the axle, and wherein the roller includes a diametrical size larger than the width of the opening of the channel the protractor is disposed, and an inner peripheral edge spacing from the axle by a gap such that it is adapted to move transversely relative to and be limited by the axle, and an outer peripheral edge urged by the lateral peripheral edge of the second platform associated with the channel, and a portion of the outer peripheral edge disposed between the ridge and base side of the channel such that the protractor is prevented from unintended disengagement from the channel.

9. The worktable as claimed in claim 1 wherein the at least one second platform includes a plurality of orifices formed therein, and wherein the at least one second platform is fixed to the mounting structure by a plurality of engaging devices and fasteners engaging with the engaging devices respectively, and with each of the plurality of engaging devices disposed in one of the plurality of orifices of the second platform and prevented from disengagement therefrom.

10. The worktable as claimed in claim 9 wherein each of the plurality of engaging device includes a body, a hole extending from a proximal end to a distal end of the body and with a size smaller than a diametrical size of the body, and a plurality of slots extending along the body in a first direction, and with each of the plurality of slots extending transversely to the first direction and diametrically from one point on an outer periphery of the body to another point and across the hole such that the hole is connected with and is in communication with the slot, and wherein each of the plurality of engaging devices includes a pressing member disposed in the hole of the body such that the body is expanded by the pressing member and includes its outer periphery abutting against a circumferential wall of the orifice.

11. The worktable as claimed in claim 10 wherein each of the plurality of engaging devices includes a pushing member disposed in the hole to urge the pressing member to cause the engaging device to be tight-engaged in the associated orifice.

12. The worktable as claimed in claim 11 wherein each of the plurality of engaging devices includes a groove recessed therefrom and extending annularly on its outer periphery therealong, and wherein the groove includes a clip engaged therein, and with the associated orifice includes a recess formed therein and in which the clip is partially engaged.

13. The worktable as claimed in claim 1 further comprising a track mechanism, and wherein the at least one second platform includes a lateral peripheral edge cooperating with the lateral peripheral edge of the first platform to define a side on which the track mechanism is mounted.

14. The worktable as claimed in claim 1 wherein the at least one second platform includes a plurality of orifices formed therein, and wherein the at least one second platform is fixed to the mounting structure (90) by a plurality of magnetic members and fasteners engaging with the magnetic members respectively, and with each of the plurality of magnetic members magnetically attracted to one of the fasteners upon fixing the at least one second platform to the mounting structure, and with each of the plurality of magnetic members disposed in one of the plurality of orifices of the second platform and prevented from disengagement therefrom.
